(19) United States
(12) Patent Application Publication
(10) Pub. No.: US 2012/0004924 A1
(43) Pub. Date: Jan. 5, 2012

(54) METHOD AND APPARATUS FOR PROVIDING IMPROVED OUTCOMES OF COMMUNICATIONS INTENDED TO IMPROVE BEHAVIORS OF THE RECIPIENT

(75) Inventors: Stan Kachnowski, New York, NY (US); Robert Jahreis, Branford, CT (US); Ilene Hollin, New York, NY (US); Brian Bertha, Danville, CA (US)

(73) Assignee: McKesson Specialty Arizona Inc.

(21) Appl. No.: 12/827,654

(22) Filed: Jun. 30, 2010

(51) Int. Cl. G06Q 50/00; G06Q 90/00

(52) U.S. Cl. 705/2; 705/500

(57) ABSTRACT

A method for providing targeted messaging for improved outcomes of communications intended to improve behaviors may include determining a profile category of an entity based at least on a correlation of personal information of the entity to characteristics of at least one of a plurality of profile categories, selecting a communication plan defining communication attributes to be employed in communicating with the entity regarding a patient care protocol based at least on the profile category determined, and directing communication of at least one message to the entity in accordance with the communication plan. A corresponding computer program product and apparatus are also provided.

### TECHNOLOGICAL FIELD

Embodiments of the present invention relate generally to health care management solutions and, more particularly, relate to the provision of a mechanism by which to improve outcomes related to communications intended to create positive change in the behavior of the recipient.

### BACKGROUND

Many aspects of the provision of medical care and the management of many aspects of the healthcare system now involve the use of computers and computer applications. For example, recent efforts have been made to move to electronic medical records (EMR). With clinical documentation systems moving to electronic media, clinical data may be available for incorporation into a number of different applications designed to assist in the management or use of such data. Computerized physician order entry (CPOE) is another example of a development that may improve the ability to electronically access information related to physician's orders. Many other applications are also being developed to utilize electronic information on people and processes to manage the provision of various aspects of patient care including personal health records, health risk assessments and automated interactive voice response calling systems which are intended to reinforce positive behavior in a variety of actors (e.g. patients, providers, care givers) in healthcare.

As the availability of electronic clinical data is increasing, the demand for applications that utilize such data to provide information, guidance and services is also increasing. Many applications have been developed to assist hospitals, clinics, doctors, insurance companies, and other healthcare related service providers with various aspects of improving patient care and organizational management. However, in many cases, regardless of the ability of a healthcare related service provider to streamline their own information management and internal processes, the overall success of any healthcare plan also relies largely on creating and reinforcing positive behaviors by various participants (e.g. patients, physicians, care givers, etc.). Thus, efforts to influence positive change are often dependent upon behavior, which may be outside of the control of healthcare service providers.

Many efforts to influence positive change involve sending messages or reminders to patients, providers and other participants in a one-size-fits-all mentality. However, the effects of these types of messages may not be clear and therefore, their value may not be determinable. Accordingly, it may be desirable to provide a mechanism by which to improve the intended behaviors expected of the recipient.

### BRIEF SUMMARY

A method, apparatus and computer program product are therefore provided to enable the provision of improved outcomes of communications intended to improve behaviors. Accordingly, for example, patient response to specific types of contact may be measured so that modes of communication that provide an increased likelihood of impacting the behavior of a particular patient may be selected. In this regard, for example, embodiments of the present invention may enable the selection of specific modes of communication for impacting patient behavior.

In one exemplary embodiment, a method for providing targeted messaging for improved behavior change is provided. The method may include determining a profile category of an entity based at least on a correlation of personal information of the entity to characteristics of at least one of a plurality of profile categories, selecting a communication plan defining communication attributes to be employed in communicating with the entity regarding a patient care protocol based at least on the profile category determined, and directing communication of at least one message to the entity in accordance with the communication plan.

In another exemplary embodiment, a computer program product for providing targeted messaging for improved behavior is provided. The computer program product may include at least one computer-readable storage medium having computer-executable program code instructions stored therein. The computer-executable program code instructions may include program code instructions for determining a profile category of an entity based at least on a correlation of personal information of the entity to characteristics of at least one of a plurality of profile categories, selecting a communication plan defining communication attributes to be employed in communicating with the entity regarding a patient care protocol based at least on the profile category determined, and directing communication of at least one message to the entity in accordance with the communication plan.

In another exemplary embodiment, an apparatus for providing targeted messaging for improved behavior is provided. The apparatus may include processing circuitry. The processing circuitry may be configured for determining a profile category of an entity based at least on a correlation of personal information of the entity to characteristics of at least one of a plurality of profile categories, selecting a communication plan defining communication attributes to be employed in communicating with the entity regarding a patient care protocol based at least on the profile category determined, and directing communication of at least one message to the entity in accordance with the communication plan.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating a system for providing targeted messaging for improved behavior according to an exemplary embodiment of the present invention;

FIG. 2 is a block diagram showing various components that may be included in an apparatus for providing targeted messaging for improved behavior according to an exemplary embodiment of the present invention; and

FIG. 3 is a block diagram according to a method for providing targeted messaging for improved behavior according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, embodiments of the present invention are aimed at providing a mechanism by which to improve the outcomes of communications intended to improve behaviors. Most common programs distribute messages to patients, physicians and other participants that are aimed at improving a behavior or set of behaviors. However, the messages are typically sent over the same channels to very broad groups of people or to a very select group of people if a high cost channel (e.g. phone calls) is employed. The information age in which we currently live can often cause information overload for many people. People are bombarded with spam email messages, blast marketing and numerous other types of communications on a nearly daily basis. Accordingly, the sending of messages aimed at improving behaviors can often result in those messages being passed over and their effectiveness being marginalized. Conversely, employing more direct communications such as phone calls to the recipient is limited by cost and is therefore used in very select situations.

Some embodiments of the present invention may enable messages to be provided in a manner that is more likely to achieve intended results. In this regard, for example, patient response to specific types of contact may be measured using reconciled information of message receipt and information on outcomes and participant characteristics so that modes of communication that provide an increased likelihood of impacting the behavior of a particular actor may be selected. Moreover, the characteristics of a specific actor may be used to tailor the types of messages, or even sequences or combinations of messages to be provided to specific patients based on the characteristics. Thus, in some cases, the selection of specific modes of communication that are most likely to positively impact behavior may be undertaken. As indicated above, example embodiments may provide for improvements in positive impacts on behavior for a variety of different actors or entities. Thus, although an example will be described in detail below in which the entity is a patient, it should be appreciated that this example is not provided to limit embodiments of the present invention, but instead is provided to serve as one detailed example. Embodiments may also be practiced with respect to other entities including, for example, care providers or other healthcare related actors.

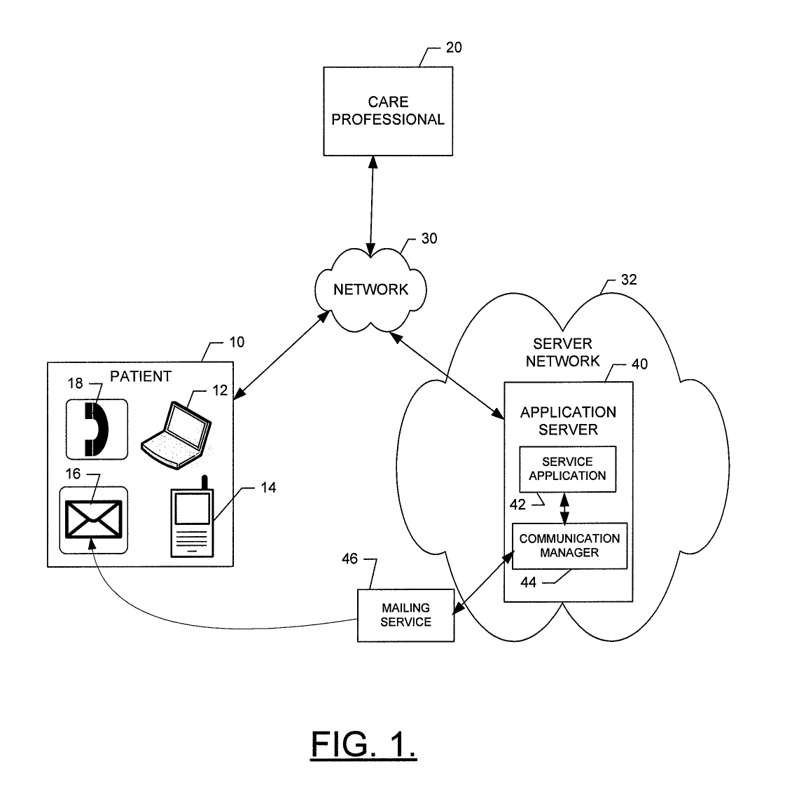

An example embodiment will now be described in reference to FIG. 1, which illustrates an exemplary system in which an embodiment of the present invention may be employed. As shown in FIG. 1, a system according to an exemplary embodiment may include one or more patients (e.g., patient 10) that may, in some cases, be reachable via various different modes of communication. For example, the patient 10 may have a personal computer (PC) or laptop computer 12 via which email messages or other multimedia messages may be received. Alternatively or additionally, the patient 10 may have a mobile telephone, personal digital assistant or other mobile communication device 14 that may receive phone calls, text messages, emails or other communications. The patient 10 may also or alternatively be reachable by regular mail 16 or via landline telephone 18. As such, with respect to phone calls and various types of electronic messaging, the patient 10 may generally be reachable by sending messages over a network 30.

The network 30 may be a data network, such as a local area network (LAN), a metropolitan area network (MAN), a wide area network (WAN) (e.g., the Internet), and/or the like. However, in some cases, the network 30 may be a wired or wireless telephone network. As such, communication between the network 30, the patients and the other devices or databases (e.g., servers) to which the network 30 may be coupled can be accomplished by either wireline or wireless communication mechanisms and corresponding protocols.

In some embodiments, the network 30 may also be connected to, or be capable of providing a connection to, a care professional 20 such as a doctor's office, hospital, insurance provider, care manager, or other healthcare related service professional. The care professional 20 may also have access to one or more of the modes of communication described above.

In an exemplary embodiment, devices to which the network 30 may be coupled may include one or more application servers (e.g., application server 40), which may form respective elements of a server network 32. Although the application server 40 is referred to as a “server”, this does not necessarily imply that it is embodied on a single device. As such, for example, a server may include a server bank or multiple servers. Moreover, a server could simply be a computer or other computing device acting in a server capacity with respect to the provision of a service to another device (e.g., a communication device of the patient 10 or the care professional 20) without being a blade server including rack units and/or the like. The application server 40 may include hardware and/or software for configuring the application server 40 to perform various functions. As such, for example, the application server 40 may include processing logic and memory enabling the application server 40 to access and/or execute stored computer readable instructions for performing various functions. In an exemplary embodiment, one function that may be provided by the application server 40 may be the provision of any of a plurality of services with respect to the patient 10 and/or the care professional 20. As such, in various exemplary embodiments, certain operations and functionalities described herein in relation to the provision of targeted messaging for improved patient adherence may be fully implemented at one device, or may be implemented in a distributed fashion with different activities being shared between multiple devices. In some examples, the application server 40 may include a service application 42 comprising stored instructions for accessing information and providing such information to various communication devices according to a specified mode of communication. For example, the service application 42 may be capable of placing a telephone call, sending an email or text message or otherwise contacting the patient 10 according to a specified mode of communication based on contact information associated with the patient 10.

In an example embodiment, the application server 40 may also host a communication manager 44 configured to determine specific modes of communication and communication parameters for use in contacting the patient 10 (and/or the care professional 20) to improve adherence according to an example embodiment. As such, the communication manager 44 may utilize specific information about the patient 10 (and perhaps also a plurality of other patients) to select a communication plan for sending one or more messages to the patient 10 according to corresponding selected modes of communication. The communication plan may define communication attributes to be employed in communicating with the entity regarding a patient care protocol based at least in part on the profile category of the entity to which the communication plan pertains. As such, in some cases, the communication plan may define an escalating or dynamic plan for repeated or cyclical groupings of messages to be sent in an effort to improve behavior. The communication plan may therefore define an optimization for selection of a message or series of messages to which it is likely that the entity will be open to both receipt and the taking of positive action indicative of a behavioral change. The information used to select the communication plan may include information about the characteristics and preferences of the actor, reconciled information on the receipt of prior messages including message channel, date received and read as well as other information related to outcomes and changes in behavior. The messages may be queued and modulated to achieve a higher likelihood of achieving behavior change based on predictive factors associated with characteristics of the actor (e.g., the patient) as described below. After the communication manager 44 selects the communication plan based on actor characteristics and other related information, the communication plan may be implemented via the service application 42 for executing phone calls, sending emails, sending text messages or other electronic communications, or the communication plan may be implemented via a mailing service 46 that may be utilized to physically mail a letter or other correspondence to the actor 10.

In some embodiments, rather than being hosted by a server, the communication manager 44 may be hosted by a PC or other computer associated with an organization engaged in healthcare related service provision. Thus, in some cases, the communication manager 44 could even be hosted at a computer associated with the care professional 20.

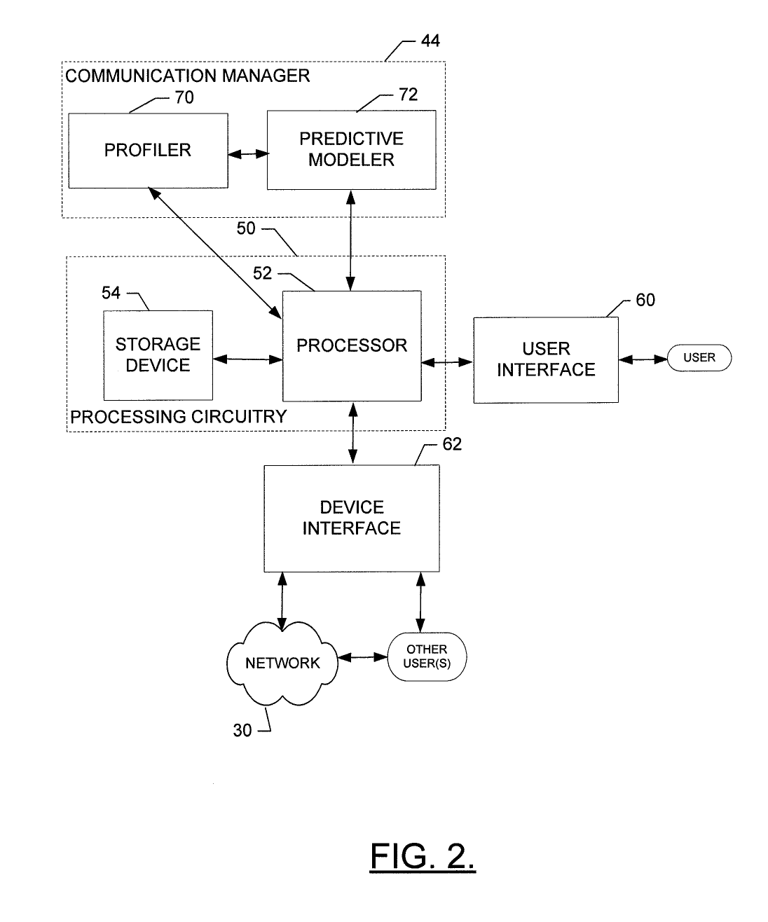

An exemplary embodiment of the invention will now be described with reference to FIG. 2. FIG. 2 shows certain elements of an apparatus for providing targeted messaging for improved outcomes of communications intended to improve behaviors according to an exemplary embodiment. The apparatus of FIG. 2 may be employed, for example, on any of a variety of communication devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40) or by devices in a client/server relationship (e.g., the application server 40 and one or more clients distributed through the network 30). Furthermore, it should be noted that the devices or elements described below may not be mandatory and thus some may be omitted in certain embodiments.

Referring now to FIG. 2, an apparatus for providing targeted messaging for improved outcomes of communications intended to improve behaviors is provided. The apparatus may include or otherwise be in communication with processing circuitry 50 that is configured to perform data processing, application execution and other processing and management services according to an exemplary embodiment of the present invention. In one embodiment, the processing circuitry 50 may include a processor 52, a storage device 54 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, and/or other input/output mechanisms. In an exemplary embodiment in which the apparatus is embodied as a server (e.g., the application server 40) or some other network devices, the user interface 60 may be fully implemented, limited, remotely located or eliminated.

The device interface 62 may include one or more interface mechanisms for enabling communication with other devices and/or networks. In some cases, the device interface 62 may be any means such as a device or circuitry embodied in either hardware, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an exemplary embodiment, the storage device 54 may include one or more non-transitory memory devices such as, for example, volatile and/or non-volatile memory that may be either fixed or removable. The storage device 54 may be configured to store information, data, applications, instructions or the like for enabling the apparatus to carry out various functions in accordance with exemplary embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases that may store a variety of files, contents or data sets. Among the contents of the storage device 54, applications (e.g., service application 42) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an exemplary embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an exemplary embodiment, the processor 52 (or the processing circuitry 50) may be embodied as, include or otherwise control the communication manager 44. The communication manager 44 may be configured to access information from various sources and utilize the information to select a communication plan for sending targeted messaging for improved patient adherence to a patient (or other entity involved in patient care (e.g., the care professional 20). In an example embodiment, the communication manager 44 may include or otherwise communicate with a profiler 70 and a predictive modeler 72.

The profiler 70 and the predictive modeler 72 may each be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the profiler 70 and the predictive modeler 72, respectively, as described herein.

The profiler 70 may be configured to determine an actor profile of the patient 10 based on information regarding the patient 10. In some embodiments, the profiler 70 may be configured to execute an algorithm for determining actor profiles. It should be noted that, as indicated above, the actor profiles could also be generated for actors other than the patient 10 and thus the patient 10 is merely one example of such an actor. The information used for determining the actor profile may be acquired directly from the actor (e.g., in response to completing an application, filling out a questionnaire, or responding to a survey) or, in some cases, may be acquired indirectly. Indirect acquisition of information may include acquisition of information from a third party source (typically with actor permission), may be observed based on actor activity, or may be received via reports on actor activity (e.g., reconciled message status data, reconciled pharmacy data, medical record data, lab data etc.). The information may include personal information such as contact information (e.g., phone number, email address, mailing address, and/or the like), demographic information (e.g., age, race, gender, geographic region, career, etc.) and/or health status information (type of disease for which the patient is being treated, medications being taken, disease stage, etc.).

The profiler 70 may also include or have access to a database of patient profile categories (or other actor profile categories) for use in profile categorization of each patient (or actor). Each profile category may be established based on demographic information and/or health status information. In some cases, the profile categories may be arbitrarily selected over age ranges, gender, disease type and/or stage. However, in other examples, the profile categories may be defined based on groupings of people that, based on information compiled from studies, tend to behave in a similar fashion (at least with respect to treatment protocol adherence). Thus, for example, a profile category may be established for men or women of a particular age range, having a particular ethnicity and/or a particular disease (e.g., a category for Caucasian women, aged 30-39 and having diabetes). In some cases, the categories may be further broken down according to income levels, education levels, social network activity, apparent communication sophistication or capabilities, and/or the like. Upon receipt of information identifying a particular actor (e.g., patient 10), the particular actor may be assigned to a profile category based on the degree of correlation between various characteristics or attributes of the particular actor and the profile categories. The profile category with which the particular actor shares the most characteristics or attributes (or perhaps the most important or significant attributes based on an observed relationship between specific attributes and corresponding behavioral predictors) may be assigned as the profile category to which the particular actor belongs.

The predictive modeler 72 may be configured to employ an algorithm for incorporating information taken from studies of actor behavior in response to specific modes of communication. In some embodiments, the studies of patient behavior may be organized by profile category. Thus, for example, a plurality of patients may be monitored with respect to their compliance related activities over a range of message stimuli in order to determine patterns in those activities relative to the message stimuli provided. Changes in behavior relating to adherence may be monitored for each studied patient to determine which message stimuli produced the best results for each patient. The patients (or other actors) may be categorized by profile category in order to determine the likelihood of positive behavior outcomes for respective different message stimuli within each profile category. Thus, for example, it may be determinable that for a particular profile category, email reminders are either a very effective, or relatively ineffective mechanism by which to target messages to patients (or other actors) within the profile category to improve their adherence. Moreover, in some cases, particular patterns of messaging, timing considerations regarding messaging and other factors may be determinable on a profile category basis. For example, some profile categories may be shown to be more likely to improve adherence in response to morning or evening reminder messages, or a sequence of messages being delivered at specific times or via specific modes of communication or patterns of modes of communication.

In some embodiments, the predictive modeler 72 may store or otherwise have access to mappings between the probability of achieving a particular response to a corresponding stimuli within each of a plurality of profile categories. The predictive modeler 72 may be configured to use the mappings to determine, for a particular profile category, the relative likelihood of improving outcomes of communications intended to improve behaviors in response to sending messages with corresponding different communication attributes. As such, the predictive modeler 72 may account for the ways in which behavior changes in actors can be measured relative to various communication attributes. The predictive modeler 72 may therefore model actor behavior changes to enable a prediction to be made as to the best communication plan to be employed based on a combination of attributes for any given actor. The model may be built using past data indicative of studies of behavioral changes made by employing messages with various different attributes.

Behavioral change may therefore be measured with respect to test subject responses by aggregating longitudinal data (e.g., data gathered over time as behavior is monitored). Thus, for programs, reconciled pharmacy claims data, message receipts, medical record data, laboratory data, survey information and other indicators of behavior may be studied in relation to the communication attributes that were employed in each case. Communication attributes may include type of message (e.g., email, regular mail, text message, phone call or voice message), time of message delivery, frequency of message delivery, pattern of message delivery (e.g., with respect to content, type of message, time/frequency of delivery, and/or the like), message length, message content, apparent message source (e.g., care provider, message service, hospital, insurance company), message number, etc.

The communication manager 44 may, according to one example, employ the predictive modeler 72 along with the profiler 70 to determine a profile category of a patient using the profiler 70 and then apply the predictive modeler 72 to determine the best communication attributes to employ in an effort to improve patient adherence for the patient based on the patient's profile category. Determining the best communication attributes may include selection of communication attributes that correlate to increased likelihood of improving outcomes of communications intended to improve behaviors relative to the rates of improved outcomes shown by using other communication attributes. The communication manager 44 may then select a communication plan defining the communication attributes to be employed with respect to the actor to improve outcomes of communications intended to improve behaviors. As such, the communication manager 44 may coordinate the functions of the profiler 70 and the predictive modeler 72 to determine the profile category of an entity or actor (e.g., based on personal information including health status and demographic information) and utilize statistical data within each profile category to determine, for the profile category of the entity or actor, the apparent best attributes to select to positively impact outcomes. In some embodiments, the communication manager 44 may develop a queue of messages for delivery to a particular actor according to the actor's profile category. The queue may include messages selected with any combination of different delivery times, different contents, different message types (e.g., email, text message, regular mail, phone call or voice mail, etc.), different message lengths (e.g., measured in terms of characters), different sources and/or the like. In other words, the communication manager 44 may determine the best combination of message attributes to be employed in an effort to improve the likelihood of positive outcomes based on the profile category to which the actor has been assigned.

Different types of messages may be provided over corresponding communication channels as managed by the communication manager 44. As such, asynchronous communication such as text messages (e.g., SMS messages), emails, regular mail, voice mail (via mobile phone or land line), and/or the like, may be used as well as synchronous communication such as interactive voice response (IVR) (via mobile phone or land line), live chat (via mobile phone or land line), and/or the like. Different message contents may also be selected with informational, instructional, motivational, reward oriented or other message contents being used as available options that have been evaluated on a profile category-wise basis in relation to employment of the predictive modeler 72. Moreover, motivational messages may be further characterized by the emotion to which the content thereof appeals (e.g., greed, fear, love, mission, hate, evidence, peer approval, etc.). As such, in some cases, the content may be selected based on the effectiveness of a particular emotional appeal with respect to a particular profile category as indicated by historical data.

In some embodiments, the source (or apparent source) of the messages may be altered by the communication manager 44 according to the communication plan selected for the profile category of the patient. In other words, the communication manager 44 may be configured to generate messages from participating entities or individuals to improve effectiveness. For example, some messages may be indicated as coming from a message service. However, the predictive modeler 72 may have data that indicates that a particular profile category is typically more responsive to emails from a doctor. Accordingly, if the doctor consents, the predictive modeler 72 may be configured to “spoof” emails from the doctor to include message contents appropriate to the current situation in order to improve patient adherence. The patient may then perceive that the doctor is responsible for pushing the corresponding message to the patient and therefore the patient may be more likely to open the message, read it, and react in the desired manner.

In some embodiments, each patient may be initially characterized as corresponding to a particular profile category and the communication plan for interacting with each patient may thereafter be conducted according to the particular profile category that was determined beforehand. In other words, assigning entities or actors to profile categories may be a static process completed one time and not modified thereafter. However, in other example embodiments, the characterization of entities or actors with respect to profile categories may be conducted dynamically. As such, the communication plan may change over time as the characterization of the actor changes based on observations regarding actor behavior. In examples where dynamic characterization is implemented, the profiler 70 may be configured to monitor actor behavior and alter the profile category of the actor based on the behavior exhibited by the actor. For example, although an actor may initially be characterized in a specific profile category based on the personal information of the actor, the behavior of the actor may indicate that the actor's behavior is actually more consistent with the behavior characteristics of another profile category. The profiler 70 may therefore alter the characterization of the patient by changing the actor's profile category. The predictive modeler 72 may then determine the best communication plan to employ for the updated profile category and the communication manager 44 may schedule messaging in accordance with the communication plan. Accordingly, some example embodiments may actually enable dynamic observation of patient behavior to enable modification of the communication plan employed with respect to the actor in order to improve the chances of achieving outcomes of communications intended to improve behaviors.

Additionally or alternatively, the profiler 70 and the predictive modeler 72 may continually update profile categories and mappings of profiles to corresponding effectiveness statistics, respectively, based on further data received regarding actor behavior for those actors being actively managed by the communication manager 44. As such, in some cases, behavioral study of a plurality of actors may be conducted to further refine the profile categories themselves or the modeled behavior associated with each respective profile category. In other words, in addition to using data obtained via previously conducted tests, the communication manager 44 may also utilize updated data received to more accurately classify the expected behavior of specific groups and to more accurately classify specific actors in corresponding groups.

In some embodiments, the behavior of the actor with respect to outcomes is the target behavior for which improvement is desired. However, embodiments of the present invention may also be implemented to improve behavior in other entities having roles to play in the treatment of patients. For example, in some cases, rather than spoofing messages from the doctor, embodiments of the present invention may be used to send messages to the doctor to ask the doctor to contact the patient to encourage patient adherence. Thus, some embodiments may also be employed to impact doctor or other third party adherence to different aspects of healthcare related activity. For example, instead of providing patient encouragement, the care professional 20 may be provided with messages to alter care provider behavior with respect to reporting data, monitoring patient activity, issuing communications, and/or the like. In such embodiments, profile categories may also be determined for care professionals to enable operation of the profiler 70 and predictive modeler 72 in similar fashion to that described above except that such operation may be performed with respect to care professionals based on data relating to care professionals.

Embodiments of the present invention may therefore be used to enable organizations responsible for the care of patients to determine the best way to provide messages to the patients to positively impact adherence to medication or disease management protocols. In this regard, evidence-based messaging may be implemented using results obtained in studies illustrating the best communication attributes (e.g., channels, contents, timing, etc.) to employ with respect to a particular type of patient in order to achieve the desired results. Example embodiments may employ a modeling concept that increases the likelihood of messages being opened, understood and thereafter altering patient behavior. As such, in a decision-making loop in which a target audience if expected to sense, interpret, decide and then act, embodiments of the present invention may induce progression through to action that achieves a desired result both faster and with more reliability. Moreover, example embodiments may reduce the effort needed to achieve desired results and therefore improve the overall efficiency and effectiveness of treatment programs. Example embodiments may therefore provide a systematic, scalable and sustainable mechanism by which to improve patient adherence via a messaging program.

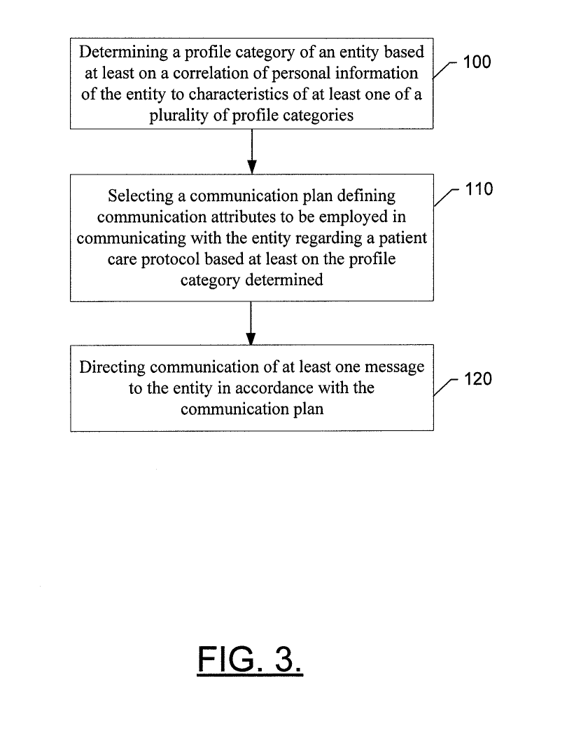

Embodiments of the present invention may therefore be practiced using an apparatus such as the one depicted in FIG. 2. However, other embodiments may be practiced in connection with a computer program product for performing embodiments of the present invention. FIG. 3 is a flowchart of a method and program product according to exemplary embodiments of the invention. Each block of the flowchart of FIG. 3, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 54) and executed by processing circuitry (e.g., processor 52). The operations of FIG. 3 may define operations for the execution of an algorithm for improving outcomes related to communications intended to create positive change in the behavior of the recipient. Furthermore, it should be noted that any of the operations of FIG. 3 may be repeated in some embodiments in order to define a cyclical mechanism by which repeated attempts at improving patient behavior in a targeted manner may be implemented.

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s). These computer program instructions may also be stored in a non-transitory computer-readable medium comprising memory that may direct a computer or other programmable apparatus to function in a particular manner, such that the instructions stored in the computer-readable memory produce an article of manufacture including instructions to implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

In this regard, a method according to one example embodiment of the invention, as shown in FIG. 3, may include determining a profile category of an entity based at least on a correlation of personal information of the entity to characteristics of at least one of a plurality of profile categories at operation 100. The method may further include selecting a communication plan defining communication attributes to be employed in communicating with the entity regarding a patient care protocol based at least on the profile category determined at operation 110 and directing communication of at least one message to the entity in accordance with the communication plan at operation 120.

In some cases, some of the operations described herein may be modified. The modifications may be included in the operations above in any combination. In an exemplary embodiment, determining the profile category of the entity may include determining the profile category of a patient or of a care professional. In some embodiments, determining the profile category of the entity may include determining the profile category of a patient based at least on profile category updates conducted using data indicative of activity of the patient. In an example embodiment, determining the profile category of the entity may include determining the profile category of a patient based at least on personal information including demographic information and health condition status information. In some embodiments, selecting the communication plan may include establishing a queue of messages. The queue of messages may be constructed based on statistical data indicating a likelihood of patient action with respect to the communication attributes of the messages of the queue. In an example embodiment, selecting the communication plan may include selecting communication attributes for the message. The communication attributes may define one or more of message length, a message source, message delivery timing or frequency, mode of communication, message content, or a number of messages. In some embodiments, selecting the communication plan may include selecting communication attributes for the message. The communication attributes may define content to be selected based on historical indications of effectiveness of a particular emotional appeal of the content with respect to the profile category. In some examples, directing communication of the at least one message may include directing sending of an email, sending of a text message, initiating a phone call, or mailing a letter to the entity.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
determining a profile category of an entity based at least on a correlation of personal information of the entity to characteristics of at least one of a plurality of profile categories;
selecting a communication plan defining communication attributes to be employed in communicating with the entity regarding a patient care protocol based at least on the profile category determined; and
directing communication of at least one message to the entity in accordance with the communication plan.

2. The method of claim 1, wherein determining the profile category of the entity comprises determining the profile category of a patient.

3. The method of claim 1, wherein determining the profile category of the entity comprises determining the profile category of a care professional.

4. The method of claim 1, wherein determining the profile category of the entity comprises determining the profile category of the entity based at least on profile category updates conducted using data indicative of activity of the patient.

5. The method of claim 1, wherein determining the profile category of the entity comprises determining the profile category of the entity based at least on personal information including demographic information and health condition status information.

6. The method of claim 1, wherein selecting the communication plan comprises establishing a queue of messages, the queue being constructed based on statistical data indicating a likelihood of entity action with respect to the communication attributes of the messages of the queue.

7. The method of claim 1, wherein selecting the communication plan comprises selecting communication attributes for the message, the communication attributes defining one or more of message length, a message source, message delivery timing or frequency, mode of communication, message content, or a number of messages.

8. The method of claim 1, wherein selecting the communication plan comprises selecting communication attributes for the message, the communication attributes defining content to be selected based on historical indications of effectiveness of a particular emotional appeal of the content with respect to the profile category.

9. The method of claim 1, wherein directing communication of the at least one message comprises directing sending of an email, sending of a text message, initiating a phone call, or mailing a letter to the entity.

10. An apparatus comprising processing circuitry configured to:
determine a profile category of an entity based at least on a correlation of personal information of the entity to characteristics of at least one of a plurality of profile categories;
select a communication plan defining communication attributes to be employed in communicating with the entity regarding a patient care protocol based at least on the profile category determined; and
direct communication of at least one message to the entity in accordance with the communication plan.

11. The apparatus of claim 10, wherein the processing circuitry is configured to determine the profile category of the entity by determining the profile category of a patient.

12. The apparatus of claim 10, wherein the processing circuitry is configured to determine the profile category of the entity by determining the profile category of a care professional.

13. The apparatus of claim 10, wherein the processing circuitry is configured to determine the profile category of the entity by determining the profile category of the entity based at least on profile category updates conducted using data indicative of activity of the patient.

14. The apparatus of claim 10, wherein the processing circuitry is configured to determine the profile category of the entity by determining the profile category of the entity based at least on personal information including demographic information and health condition status information.

15. The apparatus of claim 10, wherein the processing circuitry is configured to select the communication plan by establishing a queue of messages, the queue being constructed based on statistical data indicating a likelihood of entity action with respect to the communication attributes of the messages of the queue.

16. The apparatus of claim 10, wherein the processing circuitry is configured to select the communication plan by selecting communication attributes for the message, the communication attributes defining one or more of message length, a message source, message delivery timing or frequency, mode of communication, message content, or a number of messages.

17. The apparatus of claim 10, wherein the processing circuitry is configured to select the communication plan by selecting communication attributes for the message, the communication attributes defining content to be selected based on historical indications of effectiveness of a particular emotional appeal of the content with respect to the profile category.

18. The apparatus of claim 10, wherein the processing circuitry is configured to direct communication of the at least one message by directing sending of an email, sending of a text message, initiating a phone call, or mailing a letter to the entity.

19. A computer program product comprising at least one computer-readable storage medium having computer-executable program code instructions stored therein, the computer-executable program code instruction comprising program code instructions for:
determining a profile category of an entity based at least on a correlation of personal information of the entity to characteristics of at least one of a plurality of profile categories;
selecting a communication plan defining communication attributes to be employed in communicating with the entity regarding a patient care protocol based at least on the profile category determined; and
directing communication of at least one message to the entity in accordance with the communication plan.

20. The computer program product of claim 20, wherein program code instructions for selecting the communication plan include instructions for establishing a queue of messages, the queue being constructed based on statistical data indicating a likelihood of entity action with respect to the communication attributes of the messages of the queue.
